(19) United States
(12) Patent Application Publication
(10) Pub. No.: US 2016/0001103 A1
(43) Pub. Date: Jan. 7, 2016

(54) Method of Warning of an Abnormality of an Air Purifier of a Respirator

(71) Applicant: OTOS Wing Co., Ltd., Seoul (KR)

(72) Inventor: Moon-Young HUH, Seoul (KR)

(73) Assignee: OTOS Wing Co., Ltd., Seoul (KR)

(21) Appl. No.: 14/755,162

(22) Filed: Jun. 30, 2015

(30) Foreign Application Priority Data
Jul. 2, 2014 (KR) 10-2014-0082491

(51) Int. Cl. A62B 9/00; A62B 18/02; A62B 7/10

(52) U.S. Cl. CPC A62B 9/006; A62B 7/10; A62B 18/02

(57) ABSTRACT

Provided is a method of warning of an abnormal state of an air purifier of a respirator, in which when an abnormality of the air purifier occurs, colors, flickering intervals, and display patterns of light emitting diodes (LEDs) are differently output in such a way that an abnormal state such as a dead battery of the air purifier which purifies polluted external air and supplies the purified air to a worker, an error caused by a blockage of a filter unit due to foreign substances, an abnormality in a load rate of the filter unit, and an error, abnormality, failure and danger caused by the expiration of an operation time and a replacement of the filter unit is warned and at the same time informed to other workers who are working near the worker to prevent a dangerous situation in which the polluted external air which is not filtered and purified is inhaled by the worker through the respirator. A technical configuration for the method of warning of the abnormal state of the air purifier of the respirator includes the respirator a worker wears, the air purifier connected to the respirator through an air supply tube and including the filter unit to purify polluted external air flowing thereinto, and a control unit provided to be controllable in the air purifier, wherein an error, failure, and dangerous situation of the air purifier and the filter unit are warned and informed to other workers near the worker wearing the air purifier through an LED warning window.

### CROSS-REFERENCE TO RELATED APPLICATION

This application claims priority to and the benefit of Korean Patent Application No. 2014-0082491, filed on Jul. 2, 2014, the disclosure of which is incorporated herein by reference in its entirety.

### BACKGROUND

1. Field of the Invention

The present invention relates to an air purifier of a respirator, and more particularly, to a method of warning of an abnormality of an air purifier of a respirator in which abnormal states such as an error, failure, and danger of the air purifier, which filters polluted external air and supplies purified air to a worker who works in an extreme environment through an air supply tube, and a filter unit are warned and informed to other workers near the worker to allow the other workers to warn or inform the worker of the abnormal state.

2. Discussion of Related Art

Generally, respirators applied to hard hats, used while welding, applied to face shields, and used against asbestos are products used in various industrial fields in extreme environments such as welding, construction, and civil engineering to prevent safety accidents which may occur while workers are working.

Such respirators applied to hard hats, used while welding, applied to face shields, and used against asbestos, which are placed on heads of workers who are working in extreme environments, include air purifiers which purify polluted external air and supply purified air to wearers thereof in workplaces where harmful particles, fumes, and harmful odors occur and places where infectious diseases occur.

Such respirators are applied to hard hats, used while welding, applied to face shields, and used against asbestos. Here, respirators applied to hard harts are used in workplaces for welding, grinding, and sanding. Respirators used while welding are applied to workplaces for welding and grinding. Respirators applied to face shields are used while grinding, sanding, coating, and crop-dusting and used in pharmaceutical laboratories, places where general particles are generated, and places where infectious diseases occur. Also, respirators used against asbestos are used in places where asbestine particles, harmful dust particles, other contaminants, and infectious pathogens occur. Such respirators purify polluted air such as harmful dust particles, harmful odors and stench, which occur in workplaces, and supply purified air to workers or wearers.

Here, such air purifiers are connected to respirators through air supply tubes, filter polluted external air, and supply purified air to respirators placed on heads of wearers, thereby allowing wearers to easily work in enclosed spaces or spaces at a high temperature.

Meanwhile, FIGS. 1 and 2 illustrate an air purifier 50 connected to a respirator mask 20 through an air supply tube 30. The air purifier 50 includes a body 51 having an installation space 51a therein, a filter unit 53 detachably installed in the installation space 51a of the body 51 to filter and purify the polluted air supplied from the outside, and a blower (not shown) for supplying the purified air filtered by the filter unit 53 to the respirator 10 through the air supply tube 30.

Here, the filter unit 53 includes a particle removal filter or an odor removal filter. The particle removal filter is a high-efficiency filter having an average purification rate of its own capable of filtering out particles having a size of about 0.3μ, in which it is possible to allow the air to pass and to filter out 99.9% of various polluted materials, agricultural pesticides, fine dust, and infectious pathogens. The odor removal filter has an excellent deodorizing force to filter out harmful elements such as odors and stench passing through the particle removal filter.

Here, the filter unit 53 further includes a pre-filter (not shown) and wire mesh (not shown). When the filter unit 53 is installed in the installation space 51a in the body 51, a filter cover 54 which fixes the filter unit 53 and includes an inlet hole 54a to allow external air to flow therein is provided.

Due to this, the filter unit 53 including one of the odor removal filter and the particle removal filter is inserted and installed in the installation space 51 a formed in the body 51 of the air purifier 50, the pre-filter is provided outside the filter unit 53, the wire mesh is provided outside the pre-filter, and the filter cover 54 is provided outside the wire mesh while being detachably and fixedly installed in front of the body 51.

With the structure described above, polluted external air flows into the air purifier 50 through the inlet hole 54a of the filter cover 54 fixedly installed in front of the body 51. The polluted external air flowing through the filter cover 54 is supplied to the pre-filter through the wire mesh to be filtered. The air filtered by the pre-filter is supplied to the filter unit 53 formed of one of the particle removal filter and the odor removal filter to be filtered and purified. The purified air, according to the driving of the blower, is supplied to the respirator mask 20 through the air supply tube 30. Also, a supply amount of the air is controlled for each level according to the need of a wearer.

Here, a control unit (not shown) which controls a state of the filter unit 53 and various sensors is provided in the air purifier 50. A switch input unit, whose reference numeral is not shown in the drawings, which inputs an operation command such as a temperature, an air flow volume, an oxygen amount, power on/off, etc., and a liquid crystal display (LCD) panel 57 which displays various data values and the state of the filter unit 53 are provided on a top surface of the air purifier 50.

Meanwhile, the air purifier 50 has a structure which is simple and easy to be carried on the waist of the wearer using a belt, a shoulder strap, or an X-strap. The air purifier 50 is carried on the waist of a worker using the belt and the like while being used, in which the respirator mask 20 and the air purifier 50 are placed on the body of the worker and the air supply tube 30 which connects the respirator mask 20 with the air purifier 50 is installed to use. A change in air flow amount while working such as a dead battery, a blockage caused by an abnormality of a filter or a blockage caused by foreign substances is sensed, and whether the sensed change is present is displayed on the LCD panel 57 to inform the worker of it.

Meanwhile, when an abnormal state of the air purifier of the respirator and the filter unit such as an error, failure, and danger occurs, an error, failure, or danger text is simply displayed on the LCD panel provided in the air purifier, which has a limitation in warning or informing the worker who is working of the abnormal state such as an error, failure, and danger.

That is, in the case of the air purifier of the respirator and the filter unit provided therein, to inform or warn the worker of a malfunction of the air purifier, an error caused by the expiration of an operation time and a replacement time of the filter unit, an abnormality in a load rate of polluted air passing through the filter unit, and an abnormal state occurring due thereto in which polluted external air which is not filtered and purified is allowed to be inhaled by the worker, the LCD panel is provided on a top surface of the air purifier in such a way that texts for warning of an error, abnormality, failure, and danger are displayed only on a top of the air purifier through the LCD panel. Accordingly, it is difficult for the worker to recognize the texts in a work environment in which hearing and seeing are not easy due to noise and dust therein.

As described above, when the worker does not recognize and check a warning text displayed on the LCD panel due to the occurrence of the malfunction, error, or failure of the air purifier or the abnormality or error in the load rate of the filter unit, polluted external air is not purified and directly supplied to the respirator through the air supply tube to be inhaled by the worker, which causes a difficulty in breathing or exposes the worker in a defenseless state to harmful gases.

In addition, when welding fumes are included in the unpurified air supplied to the worker, the sweat of the wearer (the worker) may stick together with the welding fumes onto the periphery of the eyes and respiratory system and may bring about safety accidents such as a visual impairment, damage to skin, pneumoconiosis, etc.

### SUMMARY OF THE INVENTION

It is an aspect of the present invention to provide a method of warning of an abnormal state of an air purifier of a respirator, in which when an abnormality of the air purifier occurs, colors, flickering intervals, and display patterns of a light emitting diode (LED) are differently output in such a way that an abnormal state such as a dead battery of the air purifier which purifies polluted external air and supplies the purified air to a worker, an error caused by a blockage of a filter unit due to foreign substances, an abnormality in a load rate of the filter unit, and an error, abnormality, failure, and danger caused by the expiration of an operation time and a replacement of the filter unit is warned and informed to other workers who are working near the worker to prevent a dangerous situation in which the polluted external air which is not filtered and purified is inhaled by the worker through the respirator mask.

It is another aspect of the present invention to provide a method of warning in advance other workers who are working near a worker who is wearing an air purifier of a respirator and working of an abnormal state to prevent a danger and an urgent situation which are not recognized by the worker while working. The air purifier of the respirator may be easily used in an extreme environment such as a construction or civil engineering site, an enclosed work space, a work space at a high temperature, and a workplace where hearing and seeing are not easy due to noise or dust. It is possible to accurately inform of the abnormal state of the air purifier and the filter unit, thereby effectively protecting the worker from harmful gases and fine dust such as metal dust and metal fumes to improve work efficiency.

According to an aspect of the present invention, there is provided a method of warning of an abnormal state of an air purifier of a respirator including the respirator mask a worker wears, the air purifier connected to the respirator mask through an air supply tube and including a filter unit to purify polluted external air flowing thereinto, and a control unit provided to be controllable in the air purifier, wherein an error, failure, and dangerous situation of the air purifier and the filter unit are warned and informed to other workers near the worker wearing the air purifier through a light emitting diode (LED) warning window.

Colors of LEDs of the LED warning window may be differently output to warn and at the same time inform the other workers near the worker wearing the air purifier of an abnormality of the air purifier and the filter unit.

The LEDs of the LED warning window may be output to flicker to warn and at the same time inform the other workers near the worker wearing the air purifier of an abnormality of the air purifier and the filter unit.

Flickering intervals of the LEDs may be regular or irregular but repetitive.

Flickering patterns of LEDs of the LED warning window may be differently output to warn and at the same time inform the other workers near the worker wearing the air purifier of an abnormality of the air purifier and the filter unit.

The flickering patterns of the LEDs may be regular or irregular but repetitively output.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic exploded perspective view of an air purifier of a general respirator;

FIG. 2 schematically illustrates a state in which an abnormal state is warned through a liquid crystal display (LCD) panel provided in the air purifier of the respirator of FIG. 1;

FIG. 3 is a schematic perspective view of an air purifier of a respirator according to one embodiment of the present invention;

FIG. 4 schematically illustrates an example of warning of an abnormal state by outputting different colors on a light emitting diode (LED) warning window provided in the air purifier of the respirator according to one embodiment of the present invention;

FIG. 5 schematically illustrates another example of warning of an abnormal state by outputting different flickering intervals on the LED warning window provided in the air purifier of the respirator according to one embodiment of the present invention; and

FIGS. 6 to 13 schematically illustrate other examples of warning of an abnormal state by outputting different flickering patterns on the LED warning window provided in the air purifier of the respirator according to one embodiment of the present invention.

### DETAILED DESCRIPTION OF EXEMPLARY EMBODIMENTS

Hereinafter, exemplary embodiments of the present invention will be described in detail with reference to the attached drawings. Also, the embodiments of the present invention do not limit the scope of the present invention but are merely provided as examples and may be variously modified without departing from the technical concept thereof.

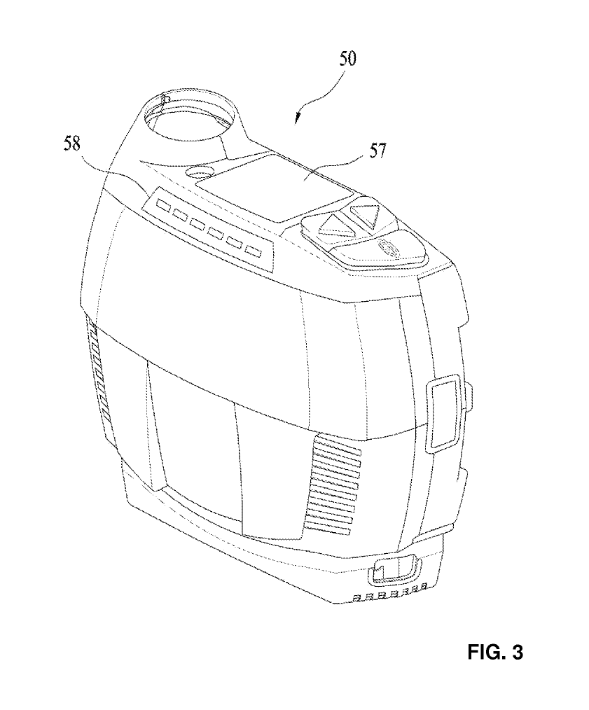

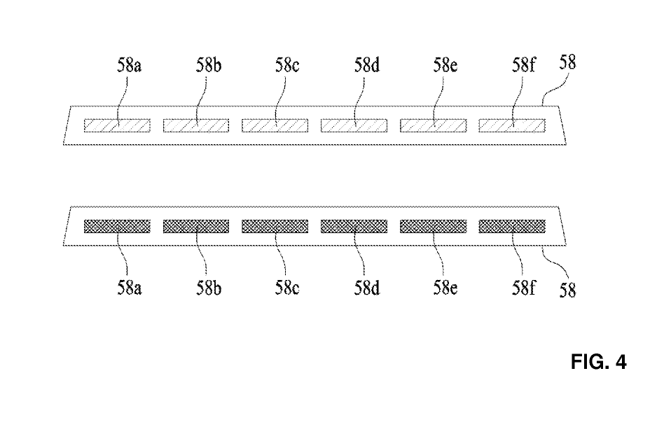

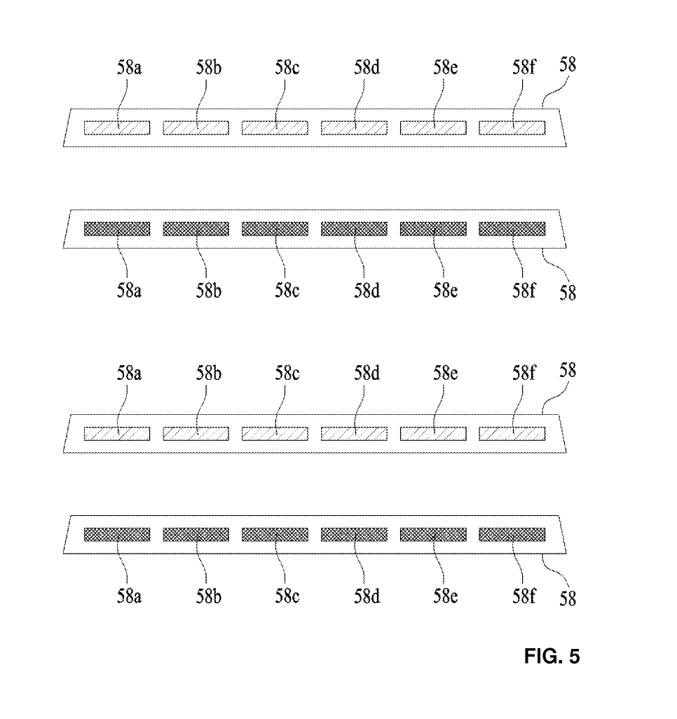

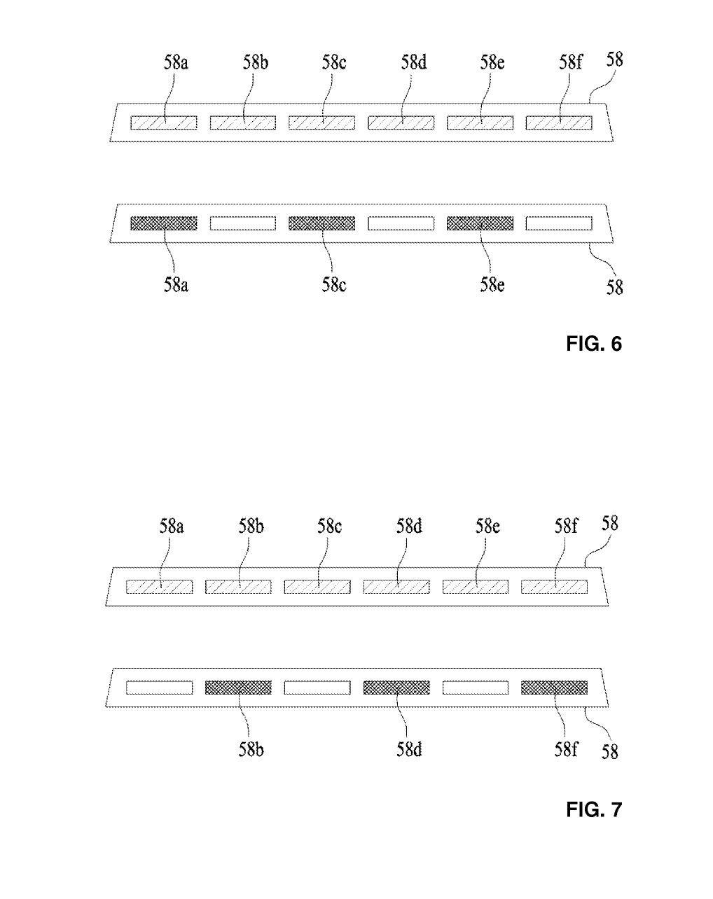

FIG. 3 is a schematic perspective view of an air purifier 50 of a respirator 10 according to one embodiment of the present invention. FIG. 4 schematically illustrates an example of warning of an abnormal state by outputting different colors on a light emitting diode (LED) warning window 58 provided in the air purifier 50 of the respirator 10 according to one embodiment of the present invention. FIG. 5 schematically illustrates another example of warning of an abnormal state by outputting different flickering intervals on the LED warning window 58 provided in the air purifier 50 of the respirator 10 according to one embodiment of the present invention. FIGS. 6 to 13 schematically illustrate other examples of warning of an abnormal state by outputting different flickering patterns on the LED warning window 58 provided in the air purifier 50 of the respirator 10 according to one embodiment of the present invention.

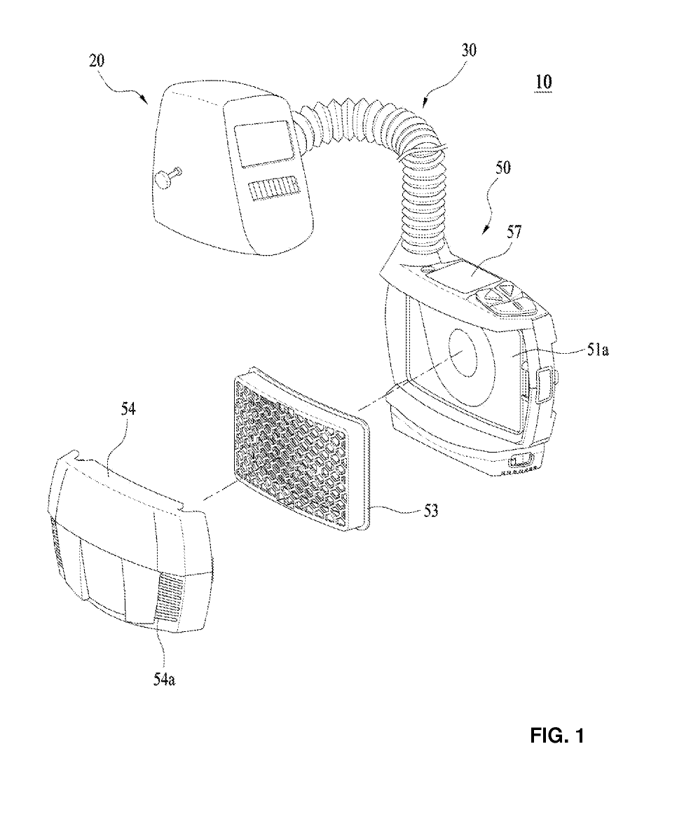

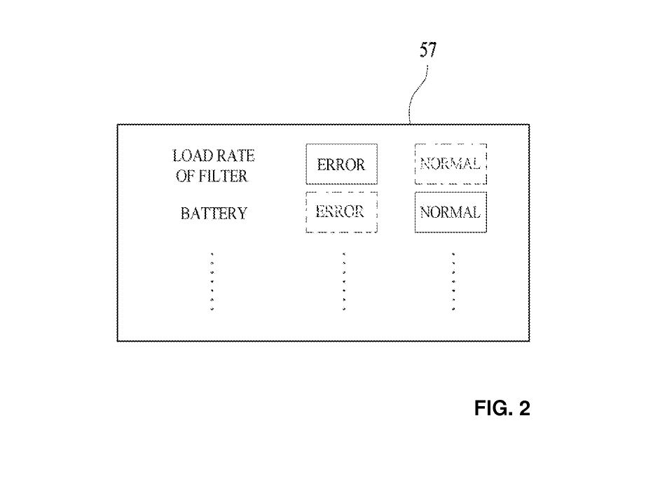

Referring to FIGS. 1 and 2, as shown in the drawings, the respirator 10 according to one embodiment of the present invention is to provide a worker with purified air in an extreme environment and an enclosed space in which particles and harmful odors such as harmful gases, harmful particles, metal dust, and metal fumes occur. The respirator 10 includes the air purifier 50 which purifies polluted external air and is interconnected with the air purifier 50 through an air supply tube 30.

Here, in the case of the air purifier 50, the polluted external air flows thereinto and is purified and then supplied to the respirator 10 through the air supply tube 30 to allow the worker to breathe in the purified air supplied through the respirator mask 20 while working, thereby preventing the inhalation and inflow of polluted material floating in a workplace through the respiratory system of the worker in advance.

For this, the air purifier 50 includes a body 51 having an installation space 51a inside a front thereof, a filter unit 53 detachably mounted and installed in the installation space 51a of the body 51 to filter and purify polluted air supplied from the outside, and a filter cover 54 coupled with the body 51 to fix the filter unit 53 mounted and installed in the installation space 51a, through which an inlet hole (not shown) to allow external air to flow therein penetrates.

Here, a pre-filter (not shown) and wire mesh (not shown) are provided on one side of the filter unit 53 to collect particles of pollutants which have relatively larger size and diameter in the air flowing from the outside.

Also, a blower (not shown) which allows the polluted external air to flow into the body 51 of the air purifier 50 and supplies purified air filtered through the filter unit 53 to the respirator 10 is provided.

Also, the air purifier 50 includes a control unit (not shown) for detecting and controlling a type of the filter unit 53 mounted and installed in the installation space 51 a of the body 51 and a load rate of the filter unit 53 and a liquid crystal display (LCD) panel 57 for displaying the type and load rate of the filter unit 53 detected by the control unit on one side of a top surface of the body 51.

With the structure described above, particles and harmful odors such as harmful particles, metal dust, and metal fumes included in the air in a workplace are filtered out and purified air is supplied to the worker who wears the respirator 10.

Here, the filter unit 53 includes a particle removal filter (not shown) or an odor removal filter (not shown) to allow the worker to insert, mount, and install the filter unit 53 appropriate for a workplace and a working condition in the air purifier 50 in order to purify polluted external air.

As described above, one of the particle removal filter and the odor removal filter, appropriate for the workplace and working condition, is mounted and installed in the installation space 51a formed in the body 51 of the air purifier 50, the pre-filter and the wire mesh are sequentially installed outside one of the particle removal filter and the odor removal filter, and then the filter cover 54 is installed in the body 51 to fix the filter unit 53, the pre-filter, and the wire mesh to the air purifier 50.

As described above, when the filter unit 53 is mounted and installed in the body 51 of the air purifier 50 and then the respirator mask 20 and the air purifier 50 operate, the polluted external air flows into the body 51 of the air purifier 50 through the inlet hole of the filter cover 54 fixedly installed in front of the body 51 of the air purifier 50, particles of pollutants which have relatively larger size and diameter in the polluted external air flowing through the inlet hole of the filter cover 54 are collected through the wire mesh and the pre-filter, and the polluted air passing through the pre-filter is supplied to the filter unit 53 to be filtered and purified, and the purified air is supplied to the respirator mask 20 through the air supply tube 30.

In this time, a supply amount of the purified air is controlled for each level, according to the need of the worker wearing the respirator 10, the polluted air which flows into the body 51 of the air purifier 50 and then the flowed and purified is supplied to the respirator mask 20 by the driving of the blower.

Here, the LED warning window 58 is provided in front of the air purifier 50 and includes a plurality of LEDs 59a, 59b, 59c, 59d, 59e, and 59f at regular intervals.

That is, the LED warning window 58 is provided in an upper portion in front of the air purifier 50 in which the filter cover 54 of the body 51 is installed and the plurality of LEDs 59a, 59b, 59c, 59d, 59e, and 59f are horizontally provided at regular intervals in the LED warning window 58.

According to one embodiment of the present invention, the LED warning window 58 having a slot form is provided in front of the air purifier 50 and the plurality of LEDs 59a, 59b, 59c, 59d, 59e, and 59f are horizontally provided at regular intervals on the LED warning window 58. However, a shape and position of the LED warning window 58 and the number and arrangement of the LEDs 59a, 59b, 59c, 59d, 59e, and 59f may be variously modified.

Meanwhile, when an error, failure, and a dangerous situation of one of the air purifier 50 and the filter unit 53 occur, the control unit warns and informs other workers near the worker wearing the air purifier 50 of it through the LED warning window 58 provided in front of the body 51.

That is, the control unit informs other workers who are working near the worker wearing the air purifier 50 of an abnormal state of one of the air purifier 50 and the filter unit 53 through the LED warning window 58 including the plurality of LEDs 59a, 59b, 59c, 59d, 59e, and 59f provided at regular intervals according to the error, failure, and dangerous situation of one of the air purifier 50 and the filter unit 53 sensed by respective sensors.

As described above, the abnormal state of one of the air purifier 50 and the filter unit 53 is warned and informed through the LCD panel 57 provided on a top surface of the air purifier 50 and simultaneously through the LED warning window 58 including the plurality of LEDs 59a, 59b, 59c, 59d, 59e, and 59f provided at regular intervals, thereby allowing the other workers who are working near the worker wearing the air purifier 50, who is exposed to the error, failure, and dangerous situation, to be informed of and check an abnormal state, and then the worker wearing the air purifier 50, who is exposed to the abnormal state, to be informed of the abnormal state to prevent a state in which the worker who is working does not recognize the error and abnormality of one of the air purifier 50 and the filter unit 53 and prevent safety accidents in advance.

For this, the abnormality of one of the air purifier 50 and the filter unit 53 is warned and informed to the other workers near the worker wearing the air purifier 50 by differently outputting colors of the plurality of LEDs 59a, 59b, 59c, 59d, 59e, and 59f of the LED warning window 58 provided in front of the air purifier 50.

That is, the colors of the plurality of LEDs 59a, 59b, 59c, 59d, 59e, and 59f horizontally provided at regular intervals on the LED warning window 58 in front of the air purifier 50 are output differently from colors emitted and output in a normal operation, thereby warning and informing the other workers who are working near the worker wearing the air purifier 50 of the abnormal state such as the error, failure, and danger of one of the air purifier 50 and the filter unit 53.

For example, as shown in FIG. 4, when one of the air purifier 50 and the filter unit 53 is normally operating while the worker is wearing the respirator 10 and the air purifier 50 and working, the plurality of LEDs 59a, 59b, 59c, 59d, 59e, and 59f provided on the LED warning window 58 are maintained emitting and outputting green color to inform the other workers who are working near the worker of a normal operation state of one of the air purifier 50 and the filter unit 53. When an abnormal state occurs due to an error and failure and one of the air purifier 50 and the filter unit 53 abnormally operates, the plurality of LEDs 59a, 59b, 59c, 59d, 59e, and 59f provided on the LED warning window 58 emit and output red color and maintain an output state to warn and at the same time inform the other workers who are working near the worker of the abnormal operation state.

According to one embodiment of the present invention, the plurality of LEDs 59a, 59b, 59c, 59d, 59e, and 59f of the LED warning window 58 output green color when one of the air purifier 50 and the filter unit 53 is in a normal operation state and output red color when one of the air purifier 50 and the filter unit 53 is in an abnormal operation state. However, the color output by the plurality of LEDs 59a, 59b, 59c, 59d, 59e, and 59f of the LED warning window 58 for warning and informing of one of the normal operation state and the abnormal operation state of one of the air purifier 50 and the filter unit 53 is not limited thereto and may be variously modified.

Meanwhile, according to one embodiment of the present invention, when one of the air purifier 50 and the filter unit 53 is normally operating or abnormally operating, the color of the plurality of LEDs 59a, 59b, 59c, 59d, 59e, and 59f of the LED warning window 58 is differently output in order to warn and at the same time inform the other workers who are working near the worker of the abnormal state such as the error, failure, and danger of one of the air purifier 50 and the filter unit 53. However, the plurality of LEDs 59a, 59b, 59c, 59d, 59e, and 59f provided on the LED warning window 58 may flicker to warn and at the same time inform the other workers who are working near the worker wearing the air purifier 50 of the abnormality of one of the air purifier 50 and the filter unit 53.

That is, the plurality of LEDs 59a, 59b, 59c, 59d, 59e, and 59f horizontally provided at regular intervals on the LED warning window 58 in front of the air purifier 50 flick to warn and at the same time inform the other workers who are working near the worker wearing the air purifier 50 of the abnormal state such as the error, failure, and danger of one of the air purifier 50 and the filter unit 53.

Here, as shown in FIG. 5, when one of the air purifier 50 and the filter unit 53 is normally operating, the plurality of LEDs 59a, 59b, 59c, 59d, 59e, and 59f provided on the LED warning window 58 maintain an emitting and outputting state. When one of the air purifier 50 and the filter unit 53 is abnormally operating, the plurality of LEDs 59a, 59b, 59c, 59d, 59e, and 59f provided on the LED warning window 58 flicker at regular time intervals with different flickering intervals to warn and at the same time inform the other workers who are working near the worker of the abnormal operation state of one of the air purifier 50 and the filter unit 53.

Here, when one of the air purifier 50 and the filter unit 53 is in the abnormal operation state, the flickering intervals of the LEDs 59a, 59b, 59c, 59d, 59e, and 59f of the LED warning window 58 may be regularly repeated or irregularly repeated and are not limited thereto.

For example, when one of the air purifier 50 and the filter unit 53 is in the abnormal operation state, the LEDs 59a, 59b, 59c, 59d, 59e, and 59f of the LED warning window 58 may be regularly and repetitively output per 0.5 or 1 second or may be irregularly and repetitively output to flicker per three seconds and per second, or per three seconds and per 0.5 second.

Also, to alert the other workers working near, when one of the air purifier 50 and the filter unit 53 is in the abnormal operation state, as time passes by, the LEDs 59a, 59b, 59c, 59d, 59e, and 59f of the LED warning window 58 may gradually flicker faster to allow the flickering intervals to become 3 seconds, 2 seconds, 1 second, and 0.5 second or may gradually flicker slower to allow the flickering intervals to become 0.5 second, 1 second, 2 seconds, and 3 seconds. If it is easy to warn or inform the other workers working near the worker of the abnormal operation state of one of the air purifier 50 and the filter unit 53, the flickering intervals of the LEDs 59a, 59b, 59c, 59d, 59e, and 59f of the LED warning window 58 may be variously modified.

Here, when one of the air purifier 50 and the filter unit 53 is normally operating, the LEDs 59a, 59b, 59c, 59d, 59e, and 59f of the LED warning window 58 may maintain emitting and outputting green color. When one of the air purifier 50 and the filter unit 53 is abnormally operating, the LEDs 59a, 59b, 59c, 59d, 59e, and 59f of the LED warning window 58 may flicker in red color. However, the color of the LEDs 59a, 59b, 59c, 59d, 59e, and 59f is not limited thereto.

Meanwhile, according to one embodiment of the present invention, the LEDs 59a, 59b, 59c, 59d, 59e, and 59f of the LED warning window 58 provided in front of the air purifier 50 flicker at different flickering intervals in order to warn and at the same time inform the other workers who are working near the worker of the abnormal state such as the error, failure, and danger of one of the air purifier 50 and the filter unit 53. However, the flickering patterns of the LEDs 59a, 59b, 59c, 59d, 59e, and 59f provided on the LED warning window 58 may be differently output to warn and at the same time inform the other workers who are working near the worker of the abnormality of one of the air purifier 50 and the filter unit 53.

That is, the flickering patterns of the plurality of LEDs 59a, 59b, 59c, 59d, 59e, and 59f horizontally provided at regular intervals on the LED warning window 58 in front of the air purifier 50 are differently output to warn and at the same time inform the other workers who are working near the worker wearing the air purifier 50 of the abnormal state such as the error, failure, and danger of one of the air purifier 50 and the filter unit 53.

With the structure as described above, when one of the air purifier 50 and the filter unit 53 is normally operating while wearing the air purifier 50 and working, the plurality of LEDs 59a, 59b, 59c, 59d, 59e, and 59f provided on the LED warning window 58 maintain an emitting and outputting state to allow the other workers working near to recognize that one of the air purifier 50 and the filter unit 53 is in the normal operation state. When one of the air purifier 50 and the filter unit 53 is abnormally operating due to an abnormal situation caused by the error and failure, only the LEDs 59a, 59b, 59c, 59d, 59e, and 59f provided and located in a certain position among the LEDs 59a, 59b, 59c, 59d, 59e, and 59f provided on the LED warning window 58 maintain the emitting and outputting state to warn and at the same time inform the other workers working near the worker of the abnormal operation state of one of the air purifier 50 and the filter unit 53. Otherwise, only the LEDs 59a, 59b, 59c, 59d, 59e, and 59f provided and located in a certain position among the LEDs 59a, 59b, 59c, 59d, 59e, and 59f provided on the LED warning window 58 repetitively flicker to warn and at the same time inform the other workers working near the worker of the abnormal operation state of one of the air purifier 50 and the filter unit 53. Otherwise, the LEDs 59a, 59b, 59c, 59d, 59e, and 59f in a certain position and the LEDs 59a, 59b, 59c, 59d, 59e, and 59f in another position among the LEDs 59a, 59b, 59c, 59d, 59e, and 59f provided on the LED warning window 58 alternately and repetitively flicker to warn and at the same time inform the other workers working near the worker of the abnormal operation state of one of the air purifier 50 and the filter unit 53.

For example, when one of the air purifier 50 and the filter unit 53 is in the abnormal operation state, as shown in FIG. 6, only the LEDs 59a, 59c, 59e located in odd-numbered positions based on the left side of the LEDs 59a, 59b, 59c, 59d, 59e, and 59f provided on the LED warning window 58 maintain the emitting and outputting state. Otherwise, as shown in FIG. 7, only the LEDs 59b, 59d, 59f located in even-numbered positions among the LEDs 59a, 59b, 59c, 59d, 59e, and 59f provided on the LED warning window 58 maintain the emitting and outputting state. As described above, the flickering patterns of the LED warning window 58 may be differently output to warn and at the same time inform the other workers working near the worker of the abnormal state of one of the air purifier 50 and the filter unit 53.

Here, when only the LEDs 59a, 59c, 59e located in odd-numbered positions based on the left side of the LEDs 59a, 59b, 59c, 59d, 59e, and 59f provided on the LED warning window 58 emit and output and then maintain the emitting and outputting state, the LEDs 59b, 59d, 59f located in even-numbered positions which do not emit and output may be turned off. When only the LEDs 59b, 59d, 59f located in even-numbered positions among the LEDs 59a, 59b, 59c, 59d, 59e, and 59f provided on the LED warning window 58 emit and output and then maintain the emitting and outputting state, the LEDs 59a, 59c, 59e located in odd-numbered positions may be turned off. However, it is not limited thereto.

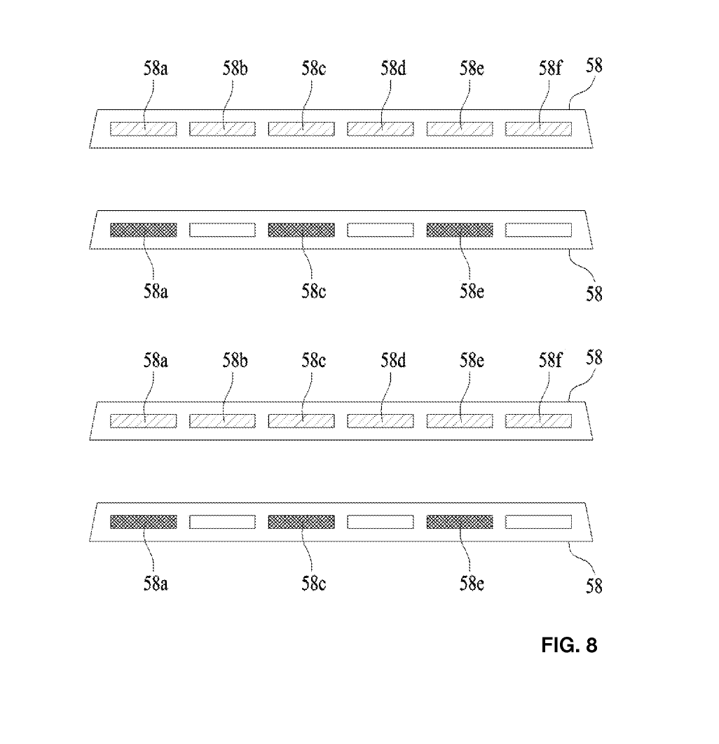

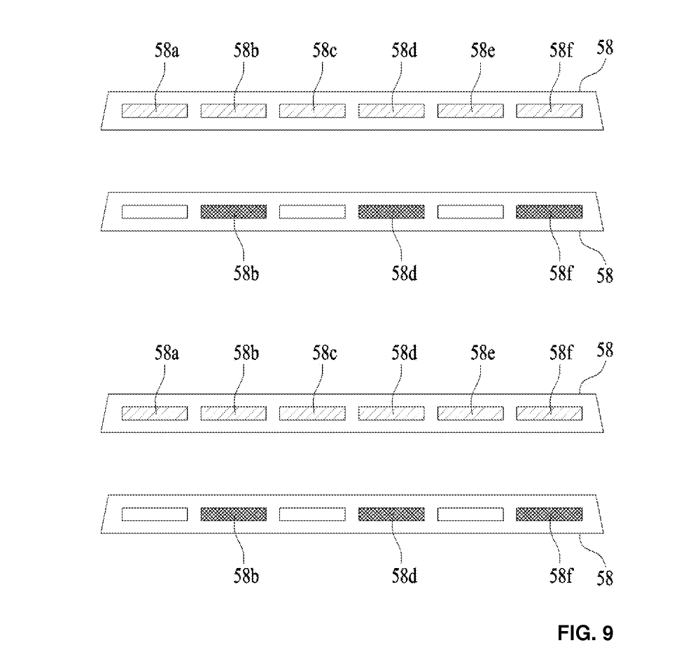

Also, when one of the air purifier 50 and the filter unit 53 is in the abnormal operation state, as shown in FIG. 8, only the LEDs 59a, 59c, 59e located in odd-numbered positions based on the left side of the LEDs 59a, 59b, 59c, 59d, 59e, and 59f provided on the LED warning window 58 repetitively flicker at the same time. Otherwise, as shown in FIG. 9, only the LEDs 59b, 59d, 59f located in even-numbered positions based on the left side of the LEDs 59a, 59b, 59c, 59d, 59e, and 59f provided on the LED warning window 58 repetitively flicker at the same time. As described above, the flickering patterns of the LED warning window 58 may be differently output to warn and at the same time inform the other workers working near the worker of the abnormal state of one of the air purifier 50 and the filter unit 53.

Even at this time, when only the LEDs 59a, 59c, 59e located in odd-numbered positions based on the left side of the LEDs 59a, 59b, 59c, 59d, 59e, and 59f provided on the LED warning window 58 repetitively flicker at the same time, the LEDs 59b, 59d, 59f located in even-numbered positions may be turned off. When only the LEDs 59b, 59d, 59f located in even-numbered positions based on the left side of the LEDs 59a, 59b, 59c, 59d, 59e, and 59f provided on the LED warning window 58 repetitively flicker at the same time, the LEDs 59a, 59c, 59e located in odd-numbered positions may be turned off. However, it is not limited thereto.

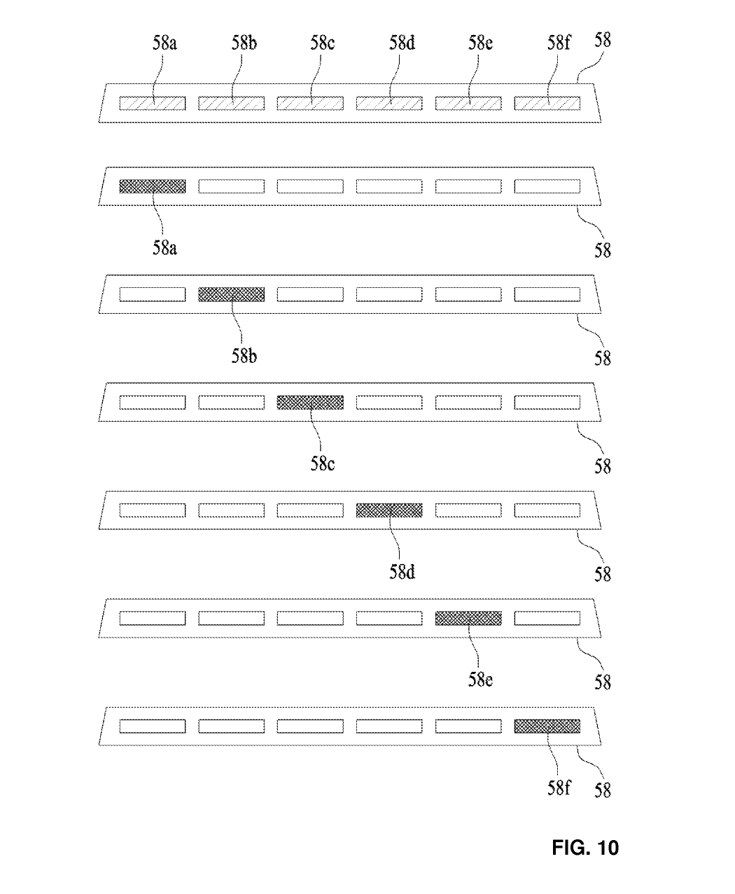

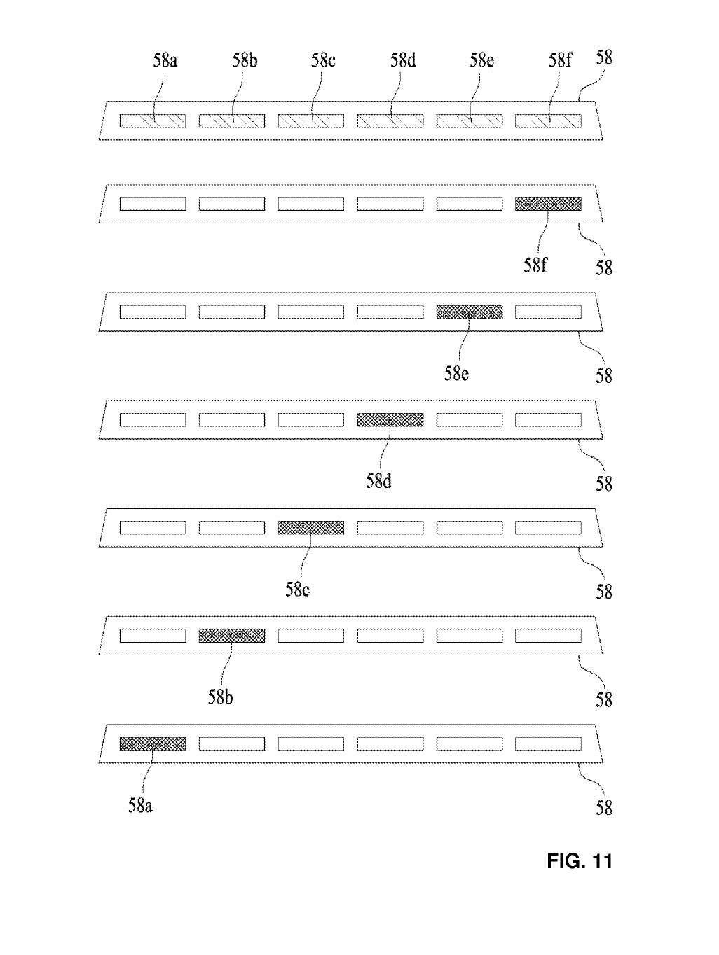

Also, when one of the air purifier 50 and the filter unit 53 is in the abnormal operation state, as shown in FIG. 10, the respective LEDs 59a, 59b, 59c, 59d, 59e, and 59f provided on the LED warning window 58 sequentially and repetitively flicker from the left toward the right at regular time intervals, or as shown in FIG. 11, the respective LEDs 59a, 59b, 59c, 59d, 59e, and 59f provided on the LED warning window 58 sequentially and repetitively flicker from the right toward the left at regular time intervals to warn and at the same time inform the other workers near the worker of the abnormal state of one of the air purifier 50 and the filter unit 53.

Here, when the respective LEDs 59a, 59b, 59c, 59d, 59e, and 59f provided on the LED warning window 58 sequentially and repetitively flicker from the left toward the right at regular time intervals, other LEDs 59a, 59b, 59c, 59d, 59e, and 59f which do not flicker are in an off state.

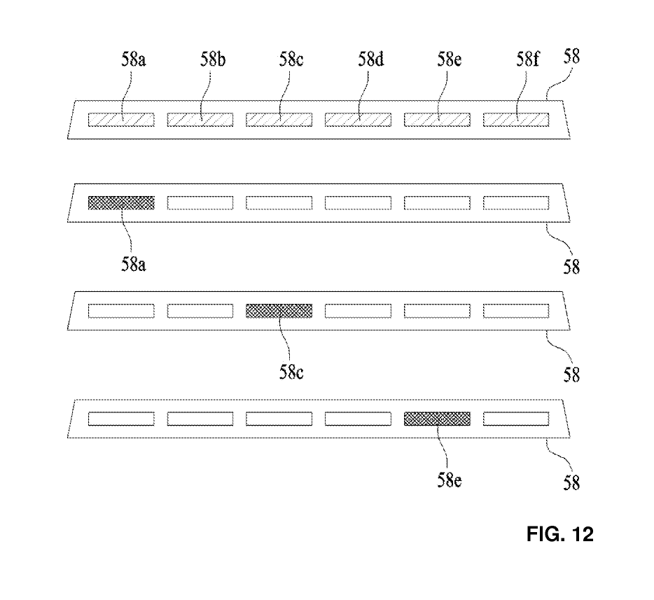

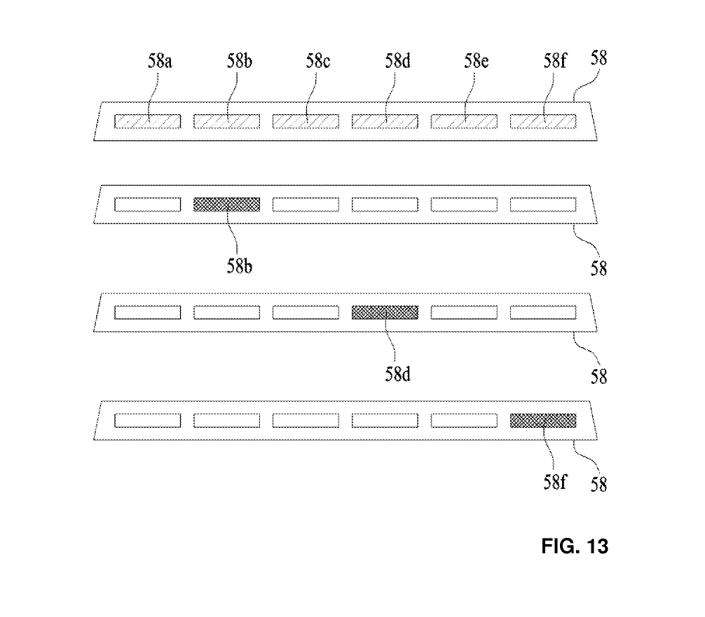

Also, when one of the air purifier 50 and the filter unit 53 is in the abnormal operation state, as shown in FIG. 12, only the LEDs 59a, 59c, 59e located in odd-numbered positions based on the left side of the LEDs 59a, 59b, 59c, 59d, 59e, and 59f provided on the LED warning window 58 sequentially and repetitively flicker from the left toward the right at regular time intervals, or as shown in FIG. 13, only the LEDs 59b, 59d, 59f located in even-numbered positions based on the left side of the LEDs 59a, 59b, 59c, 59d, 59e, and 59f provided on the LED warning window 58 sequentially and repetitively flicker from the left toward the right at regular time intervals to warn and at the same time inform the other workers working near the worker of the abnormal state of one of the air purifier 50 and the filter unit 53.

As described above, when one of the air purifier 50 and the filter unit 53 is in the abnormal operation state, the flickering patterns of the LEDs 59a, 59b, 59c, 59d, 59e, and 59f provided on the LED warning window 58 are variously output to warn and at the same time inform the other workers working near the worker of the abnormal state of one of the air purifier and the filter unit 53.

Here, when one of the air purifier 50 and the filter unit 53 is in the abnormal operation state, the flickering patterns of the LEDs 59a, 59b, 59c, 59d, 59e, and 59f of the LED warning window 58 may be regularly repeated or irregularly repeated but are limited thereto.

Meanwhile, when one of the air purifier 50 and the filter unit 53 is normally operating, the LEDs 59a, 59b, 59c, 59d, 59e, and 59f of the LED warning window 58 may maintain emitting and outputting green color. When one of the air purifier 50 and the filter unit 53 is abnormally operating, the LEDs 59a, 59b, 59c, 59d, 59e, and 59f of the LED warning window 58 may flicker in red color with various flickering patterns. However, the color of the LEDs 59a, 59b, 59c, 59d, 59e, and 59f is not limited thereto.

As described above, to warn the other workers working near the worker of the abnormality of the air purifier 50 by differently outputting the colors, flickering intervals, and display patterns of the LEDs 59a, 59b, 59c, 59d, 59e, and 59f provided on the LED warning window 58, the control unit provided in the air purifier 50 may include programs according to the colors, flickering intervals, and display patterns of the LEDs 59a, 59b, 59c, 59d, 59e, and 59f, and the LED warning window 58 may be operated using an additional circuit configuration. Hereinafter, a detailed description will be omitted.

Hereinafter, a method of warning of an abnormal state of the air purifier 50 of the respirator 10 according to one embodiment of the present invention will be described.

First, the filter unit 53 is mounted and installed in the air purifier 50 connected to the respirator 10 through the air supply tube 30, and the air purifier 50 is turned on to drive.

Here, polluted external air flows into the body 51 through the inlet hole of the filter cover 54 provided in the air purifier 50 due to the blower provided in the air purifier 50, and the air flowing into the body 51 of the air purifier 50 is purified while sequentially passing through the wire mesh, pre-filter, and the filter unit 53 and then supplied to the respirator mask 20 through the air supply tube 30 to allow the worker wearing the respirator mask 20 to breath in the air.

When an abnormal state occurs in one of the air purifier 50 and the filter unit 53 provided in the air purifier 50 while the worker wearing the respirator mask 20 on the head and face and the air purifier 50 on the waist is working in an extreme environment such as construction or civil engineering site, an enclosed work space, a work space at a high temperature, and a workplace where hearing and seeing are not easy due to noise and dust therein, other workers near the worker wearing the respirator mask 20 and the air purifier 50 are warned and informed that the abnormal state occurs in one of the air purifier 50 and the filter unit 53 through the LED warning window 58 provided in front of the body 51 in which the filter cover 54 is installed.

That is, when one of the air purifier 50 and the filter unit 53 is in a normal operation state, the respective LEDs 59a, 59b, 59c, 59d, 59e, and 59f of the LED warning window 58 provided in front of the air purifier 50 may emit and output green color and may maintain an outputting state to allow the other workers near the worker wearing the respirator 10 to recognize that one of the air purifier 50 and the filter unit 53 is normally operating. When one of the air purifier 50 and the filter unit 53 is in an abnormal operation state, the respective LEDs 59a, 59b, 59c, 59d, 59e, and 59f provided in the LED warning window 58 in front of the air purifier 50 may emit and output red color to warn and at the same time inform the other workers near the worker wearing the respirator mask 20 of the abnormal state in which one of the air purifier 50 and the filter unit 53 is abnormally operating.

Also, when one of the air purifier 50 and the filter unit 53 is in the abnormal operation state, the respective LEDs 59a, 59b, 59c, 59d, 59e, and 59f provided in the LED warning window 58 in front of the air purifier 50 may regularly flicker red color at regular time intervals or irregularly flicker in red color to warn and at the same time inform the other workers near the worker wearing the respirator mask 20 of the abnormal state in which one of the air purifier 50 and the filter unit 53 is abnormally operating.

Also, when one of the air purifier 50 and the filter unit 53 is in the abnormal operation state, flickering patterns of the respective LEDs 59a, 59b, 59c, 59d, 59e, and 59f provided on the LED warning window 58 in front of the air purifier 50 may be differently output to warn and at the same time inform the other workers near the worker wearing the respirator mask 20 of the abnormal state in which one of the air purifier 50 and the filter unit 53 is abnormally operating. Here, when the flickering patterns of the respective LEDs 59a, 59b, 59c, 59d, 59e, and 59f provided on the LED warning window 58 in front of the air purifier 50 are differently output, only the LEDs 59a, 59b, 59c, 59d, 59e, and 59f provided and located in a certain position among the LEDs 59a, 59b, 59c, 59d, 59e, and 59f provided on the LED warning window 58 maintain an emitting and outputting state to warn and at the same time inform the other workers working near the worker of the abnormal operation state of one of the air purifier 50 and the filter unit 53. Otherwise, only the LEDs 59a, 59b, 59c, 59d, 59e, and 59f provided and located in a certain position among the LEDs 59a, 59b, 59c, 59d, 59e, and 59f provided on the LED warning window 58 repetitively flicker to warn and at the same time inform the other workers working near the worker of the abnormal operation state of one of the air purifier 50 and the filter unit 53. Otherwise, the LEDs 59a, 59b, 59c, 59d, 59e, and 59f in a certain position and the LEDs 59a, 59b, 59c, 59d, 59e, and 59f in another position among the LEDs 59a, 59b, 59c, 59d, 59e, and 59f provided on the LED warning window 58 alternately and repetitively flicker to warn and at the same time inform the other workers working near the worker of the abnormal operation state of one of the air purifier 50 and the filter unit 53.

That is, when one of the air purifier 50 and the filter unit 53 is in the abnormal operation state, to warn and at the same time inform the other workers working near the worker of the abnormal operation state of one of the air purifier 50 and the filter unit 53, only the LEDs 59a, 59c, 59e located in odd-numbered positions based on the left side of the LEDs 59a, 59b, 59c, 59d, 59e, and 59f provided on the LED warning window 58 may emit and output red color or only the LEDs 59b, 59d, 59f located in even-numbered positions among the LEDs 59a, 59b, 59c, 59d, 59e, and 59f provided on the LED warning window 58 may emit and output red color. Otherwise, only the LEDs 59a, 59c, 59e located in odd-numbered positions based on the left side of the LEDs 59a, 59b, 59c, 59d, 59e, and 59f provided on the LED warning window 58 may repetitively flicker in red color or only the LEDs 59b, 59d, 59f located in even-numbered positions among the LEDs 59a, 59b, 59c, 59d, 59e, and 59f provided on the LED warning window 58 may repetitively flicker in red color. Otherwise, the respective LEDs 59a, 59b, 59c, 59d, 59e, and 59f provided on the LED warning window 58 may sequentially flicker in red color from the left toward the right at regular time intervals or the respective LEDs 59a, 59b, 59c, 59d, 59e, and 59f provided on the LED warning window 58 may sequentially emit red color from the right toward the left at regular time intervals. Otherwise, only the LEDs 59a, 59c, 59e located in odd-numbered positions among the LEDs 59a, 59b, 59c, 59d, 59e, and 59f provided on the LED warning window 58 may sequentially and repetitively flicker in red color from the left toward the right at regular time intervals or only the LEDs 59b, 59d, 59f located in even-numbered positions among the LEDs 59a, 59b, 59c, 59d, 59e, and 59f provided on the LED warning window 58 may sequentially and repetitively flicker in red color from the left toward the right at regular time intervals. However, it is not limited thereto.

As described above, while the worker wearing one of the air purifier 50 and the filter unit 53 is working, an abnormal state such as a dead battery of the air purifier 50, an abnormality in a load rate of the filter unit 53, and an error, failure and danger caused by the expiration of an operation time and a replacement of the filter unit 53 is warned and informed to the other workers near the worker, thereby preventing a dangerous situation in which the polluted external air which is not filtered and purified due to the abnormality of one of the air purifier 50 and the filter unit 53 is inhaled by the worker or wearer through the respirator 10.

As described above, according to the embodiments of the present invention, it is possible to warn other workers who are working near a worker to which an abnormal state such as a dead battery of an air purifier which purifies polluted external air while working, an error caused by a blockage of a filter unit due to foreign substances, an abnormality in a load rate of the filter unit, and an error, failure and danger caused by the expiration of an operation time and a replacement of the filter unit occurs and to inform the worker of the abnormal state, thereby preventing an urgent situation and a dangerous situation not recognized by the worker in advance.

Also, according to the embodiments of the present invention, it is possible to prevent a dangerous situation in which polluted external air may not be filtered and purified and may be inhaled by a worker through a respirator mask. It is available in an extreme environment such as a construction or civil engineering site, an enclosed work space, a work space at a high temperature, and a workplace where hearing and seeing are not easy due to noise or dust. It is possible to accurately recognize an abnormal state of a respirator, an air purifier, and a filter unit, thereby effectively protecting a worker from harmful gases and fine dust such as metal dust and metal fumes and continuously working to improve work efficiency, which is very industrially useful.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of warning of an abnormal state of an air purifier of a respirator including the respirator mask a worker wears, the air purifier connected to the respirator mask through an air supply tube and including a filter unit to purify polluted external air flowing thereinto, and a control unit provided to be controllable in the air purifier,
wherein an error, failure, and dangerous situation of the air purifier and the filter unit are warned and informed to other workers near the worker wearing the air purifier through a light emitting diode (LED) warning window.

2. The method of claim 1, wherein colors of LEDs of the LED warning window are differently output to warn and at the same time inform the other workers near the worker wearing the air purifier of an abnormality of the air purifier and the filter unit.

3. The method of claim 1, wherein LEDs of the LED warning window are output to flicker to warn and at the same time inform the other workers near the worker wearing the air purifier of an abnormality of the air purifier and the filter unit.

4. The method of claim 3, wherein flickering intervals of the LEDs are regular or irregular but repetitive.

5. The method of claim 1, wherein flickering patterns of LEDs of the LED warning window are differently output to warn and at the same time inform the other workers near the worker wearing the air purifier of an abnormality of the air purifier and the filter unit.

6. The method of claim 5, wherein the flickering patterns of the LEDs are regular or irregular but repetitively output.
